(19) United States
(12) Patent Application Publication
(10) Pub. No.: US 2022/0207478 A1
(43) Pub. Date: Jun. 30, 2022

(54) REINFORCEMENT LEARNING MODEL OPTIMIZING ARRIVAL TIME FOR ON-DEMAND DELIVERY SERVICES

(71) Applicant: Uber Technologies, Inc., San Francisco, CA (US)

(72) Inventors: Matthew Hlavacek, San Francisco, CA (US); Lizhu Zhang, San Francisco, CA (US); Lei Kang, San Francisco, CA (US); Zi Wang, San Francisco, CA (US); Raghav Gupta, San Francisco, CA (US)

(21) Appl. No.: 17/136,358

(22) Filed: Dec. 29, 2020

(51) Int. Cl. G06Q 10/08; G06N 20/00; G06N 5/04; G06Q 10/06

(52) U.S. Cl. CPC G06Q 10/0834; G06N 20/00; G06N 5/04; G06Q 50/12; G06Q 10/0835; G06Q 10/067; G06Q 10/06315

(57) ABSTRACT

A computing system can facilitate an on-demand delivery service by receiving menu item requests and transmit corresponding order requests to menu item preparers. The system can execute one or more trained predictive models using a set of current predictive metrics for the menu item preparer to generate probability curves for driver wait time and menu item sit time against a logical cost to the on-demand delivery service. The system may then utilize the curves to determine an optimal arrival time for a selected delivery provider to pick up the menu items for delivery.

### BACKGROUND

Remotely coordinated, on-demand delivery services for comestible items, such as food and drink items, typically involve a futile undertaking of attempting to predict a preparation time for each requested menu item.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example network computing system in communication with computing devices of requesting users, delivery providers, and menu item preparers of an on-demand delivery service, in accordance with examples described herein;

FIG. 2 is a flow chart describing an example method of generating optimal arrival times for drivers based on predictive metrics for menu item requests, according to examples described herein;

FIG. 3 depicts a delivery interface for a requesting user indicating an estimated time of arrival that incorporates an optimal arrival time, in accordance with examples described herein;

FIG. 4 is a block diagram illustrating an example mobile computing device, in accordance with examples described herein; and

FIG. 5 is a block diagram that illustrates a computer system upon which examples described herein may be implemented.

### DETAILED DESCRIPTION

On-demand delivery services of comestible menu items involve receiving a request from a requesting user for one or more menu items to be prepared by a menu item preparer (e.g., a restaurant) and then delivered to an address associated with the requesting user (e.g., a home or work address). Various inefficiencies have been observed that involve uncontrollable unknowns within the request-to-delivery timeline which, on a marketplace-wide scale, can represent significant inefficiencies on the side of the delivery provider, the requesting user, and the menu item preparer. These inefficiencies and wasted time can manifest in the requesting user getting the requested menu items late, hot food items getting cold, delivery providers losing additional opportunities for delivery, and decreasing user engagement with such remotely coordinated on-demand delivery services. Ideally, a requesting user will receive requested menu items as quickly as possible, which would require highly accurate predictions of menu item preparation times and driver arrival times to the menu item preparer, and the minimization of the time comestible items are left waiting for pickup. Currently, estimated times of arrival (ETA) are far more predictable than the prediction of menu item preparation time, which involves noisy ground truth data comprising variations by preparer (e.g., different restaurants), time of day (e.g., a busy lunch time versus quite afternoon), day of the week, or even the current staff on hand.

Examples described herein can complement existing preparation time prediction methods by providing reinforcement learning techniques, implemented by a computing system, that comprise one or more reinforcement models that are queried by the existent preparation time (“prep-time”) prediction model to provide a set of temporal offsets that are used to generate a predicted optimal arrival time for a driver to pick up prepared menu items from a preparer location. This optimal arrival time generated through use of the reinforcement model is purposed for minimizing or eliminating provider wait time while minimizing or eliminating item sit time (e.g., the time delta between completion of meal prep and pickup by the driver). In such examples, the existing prep-time prediction model can comprise a baseline upon which the reinforcement learning model can improve upon.

In training the reinforcement learning model, the computing system can remotely monitor real-world data (e.g., on an individual restaurant level)—comprising menu item request time, driver arrival time and wait time, item sit time, and delivery time—and tune the arrival time optimization. In many examples, the reinforcement model can include a pair of models comprising (i) an item sit time prediction model, and (ii) a provider wait time prediction model, each of which can utilize the outputted prep-time prediction from the prep-time prediction model (i.e., a predicted menu item preparation time) to calculate weighted probabilities for a set of possible item sit times and delivery provider wait times respectively (e.g., using inverse propensity weighting techniques). In doing so, the reinforcement model seeks to determine the causal effect of selecting a particular predicted arrival time for each menu item request, and compare each prior prediction to ultimately determine each prior instance's most optimal arrival time prediction.

As training input, the reinforcement model can acquire historical data for menu item preparation sources, such as menu item request times, driver arrival times, wait times for the drivers, item sit time, and delivery time. As described herein, such inputs can be individualized per menu item preparer and for each menu item to enable more granular predictions for each menu item request. In the training phase, the reinforcement model can employ any number or type of exploration techniques, such as upper bound search, bootstrap Thompson sampling, or epsilon-greedy, and/or can execute any number of simulations using inferred prep-times. For example, in the simulations, the reinforcement model can simulate timing offsets (e.g., +/−five minutes in one-minute increments) for the delivery driver's arrival time (or wait times for the driver and/or menu item post-preparation), and progress the simulations to determine how much real-world training data may be necessary to effectively tune the reinforcement model accordingly.

In the real-world training of the reinforcement model, the computing system can compare the arrival time predictions of the existing prep-time prediction model with the probability-weighted offset times outputted through execution of the reinforcement model. In one approach, the computing system can transmit arrival instructions to a matched driver to arrive at the menu item preparer early, so that the computing system may learn actual prep-times for each menu item. The computing system can log data for each prepared menu item corresponding to the predicted prep-time by the existing model, the selected optimized arrival time, a selection probability for the selected optimized arrival time, an indicator for whether the selected optimized arrival time was the same or within a threshold range of the predicted prep-time, the predicted provider wait time and/or item sit time and their weight-probabilities, and the like.

In real-world implementation, given a menu item request comprising one or more menu items to be made by a particular menu item preparer, and being received at a particular time of day and day of the week, computing system can output a menu item sit time curve and a driver wait time curve for the requested menu item(s). In certain examples, these curves can comprise probability curves represented in a Cartesian coordinate system that weighs hypothetical driver arrival time and menu item sit time against expected cost to the on-demand delivery service (e.g., financial and/or overall marketplace efficiency cost). Using these predictive curves, the computing system can generate or otherwise determine probability weightings for a set of offset times (e.g., +/−five minutes in one minute increments) corresponding to the curves.

In certain examples, these offset times can correspond to (i) a set of hypothetical provider wait times, each being associated with a probability of actual provider wait time, and (ii) a set of hypothetical item sit times, each being associated with a probability of actual item sit time. Given the driver wait time and menu item sit time curves, an optimized arrival time at the preparer can be determined or deduced by the delivery coordination aspect of the computing system (e.g., via a curve optimization using the sit time and wait time curves), which can determine available driver locations and their respective ETAs, and select a driver that will arrive at the preparer location as close to the optimized arrival time as possible.

Among other benefits, embodiments described herein provide a technical solution to the technical problem of a current inability to remotely and accurately predict menu item prep-times by menu item preparers. The use of reinforcement learning to sample multiple offset times with weighted probabilities in order to generate an optimal arrival time for a driver can result in reduced inefficiencies and enhanced user experience by all parties involved with on-demand delivery services of comestible items.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network system.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

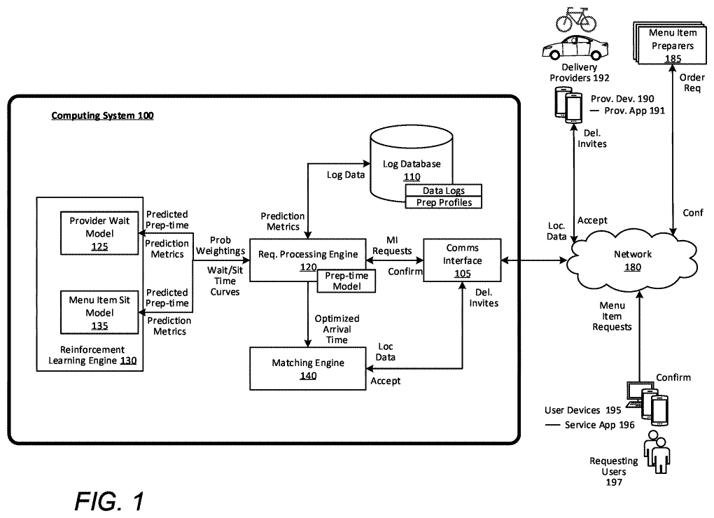

FIG. 1 is a block diagram illustrating an example network computing system 100 in communication with computing devices of requesting users 197, delivery providers 192, and menu item preparers 185 of an on-demand delivery service, in accordance with examples described herein. According to examples described herein, the computing system 100 can include a network communication interface 105 that communicates, over one or more networks 180, with (i) computing devices 195 of requesting users 197, (ii) computing devices 190 of delivery providers 192 (e.g., drivers), and (iii) computing devices of menu item preparers 185 to facilitate and remotely coordinate an on-demand delivery service.

In various examples, the computing system 100 can include a request processing engine 120 that receives menu item requests from the requesting users 197 (e.g., via an executing service application 196 on the computing devices 195 of the requesting users 197). Upon receiving a menu item request for one or more menu items (e.g., a meal) to be prepared by a menu item preparer 185 (e.g., a restaurant), the request processing engine 120 can transmit an order request to the menu item preparer 185 selected by the requesting user 197 (e.g., via the service application 196) to prepare the requested menu item(s). In conjunction, the request processing engine 120 can execute a preparation time (“prep-time”) model that predicts a prep-time for the menu item preparer 185 to prepare the requested item(s). In doing so, the request processing engine 120 can access, from a log database 110 of the computing system 100, a set of current prediction metrics specific to the menu item preparer 185 and current contextual information. For example, the log database 110 can include a preparer profile for each menu item preparer 185 that comprises historical data indicating varying prep-times for specific menu items at specific times of the day and/or days of the week.

The request processing engine 120 can determine a current time of day, day of the week, and each requested menu item from the menu item preparer 185 and generate a predicted prep-time at which the menu item preparer 185 will complete the order, making it ready for pickup. It is contemplated that the use of the predicted prep-time based solely on historical information may still result in significant variation in actual prep-times, which involve highly unpredictable variables that cannot be accounted for, despite having logged a long history of prep-time data in the menu item preparer's profile. One technique that can be utilized to provide additional support to the predictions is reinforcement learning, which can leverage contextual bandit problem concepts to maximize long-term accuracy of the predictions.

According to examples provided herein, the computing system 100 can implement a reinforcement learning engine 130 that can be trained to supplement the prep-time predictions of the request processing engine 120 by generating weighted probabilities for multiple offset times using the historical data and current predictive metrics for any given menu item request. In various examples, the reinforcement learning engine 130 be implemented as a single model or multiple models that utilize(s), as an initial input, the predicted prep-time from the request processing engine 120 to ultimately determine an optimal arrival time for a delivery provider 192 (e.g., a driver, a bicyclist, etc.) to pick up the requested menu item(s). In doing so, the reinforcement learning engine 130 can sample or determine weightings or probabilities for multiple alternative times using the current predictive metrics and historical data to generate an optimized arrival time that can be used by a matching engine 140 of the computing system 100 to select a particular delivery provider 192 to service the menu item request.

In the example shown in FIG. 1, the reinforcement learning engine 130 can execute a provider wait time model 125 and an item sit time model 135 (e.g., a time in which the requested menu item has been prepared and sits idle, waiting for pickup), each of which can receive, as input, the predicted prep-time outputted by the request processing engine 120 (through execution of the prep-time prediction model). Using the predicted prep-time, the provider wait time model 125 can calculate a set of probabilities for a corresponding set of theoretical offset arrival times or wait times for the driver, based on the historical data of the menu item preparer and historical prep-times for the requested menu items(s) (e.g., plus or minus five minutes in one-minute increments). Also using the predicted prep-time, the item sit time model 135 can calculate a set of probabilities for a corresponding set of theoretical offset item sit times for the requested menu items, based on the historical data of the menu item preparer and historical prep-times for the requested menu items(s) (e.g., also plus or minus five minutes in one-minute increments).

These offset times, including their probability weightings, can be submitted to the request processing engine 120 in order to generate an optimized arrival time for a selected delivery provider 192. In certain scenarios, the predicted prep-time generated through execution of the prep-time model may be selected as the optimized arrival time. In other scenarios, the request processing engine 120 may adjust the predicted prep-time based on the probability weightings attached to the offset times generated by the provider wait time model 125 and the menu item sit time model 135 respectively.

During the training phase, the reinforcement learning model 130 can acquire historical preparer data from the preparer profiles, in the database 110, of any number of menu item preparers (e.g., historical prep-times during certain times of the day and/or days of the week), typical prep-times for specified menu items for each preparer, and the like. For simulations in the training phase (e.g., an exploration phase), the reinforcement learning engine 130 can employ any number or type of exploration techniques, such as upper bound search, bootstrap Thompson sampling, or epsilon-greedy, and/or can execute any number of simulations using inferred prep-times and corresponding driver arrival times. For example, when executing the simulations, the models 125, 135 executed by the reinforcement learning engine 130 can simulate a menu item request for a particular preparer 185 and determine a set probability weightings for a set of timing offsets given the particular predicted prep-time (e.g., +/−five minutes in one-minute increments) for the delivery driver's arrival time to tune the reinforcement learning model.

In the real-world training of the models 125, 135, the request processing engine 120 can compare the prep-time predictions of the existing prep-time prediction model with the probability weighted offset times outputted through execution of the provider wait time model 125 and the item sit time model 135. In one approach for training the models 125, 135, a matching engine 140 of the computing system 100 can receive the optimized arrival time and purposefully transmit a delivery invitation to a matched delivery provider 192 that has an estimated time of arrival (ETA) to the preparer's 185 location that is a certain amount of time earlier that the optimized arrival time. Thus, the selected delivery provider 192 can arrive at the menu item preparer 185 early, so that the reinforcement learning engine 130 can learn and log actual prep-times for each requested menu item. The request processing engine 120 can log data for each prepared menu item corresponding to the predicted prep-time by the existing prep-time model, the optimized arrival time generated based on the probability-weighted offsets, an indicator for whether the selected optimized arrival time was the same or within a threshold range of the predicted prep-time, the predicted provider wait time and/or item sit time for the optimized arrival time, and the like.

In variations, the reinforcement learning engine 130 can remotely monitor real-world data (e.g., on an individual restaurant level)—comprising menu item request time, item prep-time, delivery provider 192 arrival time and wait time, item sit time, and delivery time—and tune the models 125, 135 accordingly. As described herein, the reinforcement learning engine 130 can continuously retrain the models 125, 135 as real-world results are realized in order to fine-tune the models 125, 135 for increased accuracy and robustness. As a result, the provider wait time model 125 and the menu item sit time model 135 can directly receive and process the prediction metrics for the requested menu item from the prep-time profile of the menu item preparer from the log database 110, and generate a wait time curve and menu item sit time curve respectively that can each represent a set of hypothetical arrival times versus cost to the on-demand delivery service. Based on the driver sit time curve and the menu item wait time curve, the request processing engine 120 can determine an optimized arrival time for a delivery provider 192 to arrive at a location of the menu item preparer 185 (e.g., a restaurant address) and pick up the requested menu item(s) for delivery.

In such implementations, given a menu item request comprising one or more menu items to be made by a particular menu item preparer 185, and being received at a particular time of day and day of the week (e.g., corresponding to the prediction metrics for the menu item preparer 185 in the preparer's profile), the provider wait time model 125 can output a driver wait time curve that maps hypothetical driver wait times on one axis and cost to the on-demand delivery service on a second axis. Additionally, given the same menu item request and the same prediction metrics, the menu item sit time model 135 can output a menu item sit time curve that maps hypothetical menu item sit times on one axis and cost to the on-demand delivery service on the second axis. As described herein, these curves can be represented in a Cartesian coordinate system that weighs both wait and sit times against cost to the on-demand delivery service. Using these predictive curves, the request processing engine 120 can execute a curve optimization to determine an optimal arrival time for a delivery provider at the location of the menu item preparer 185.

In one aspect, the optimized arrival time can comprise a predicted lowest cost time to the on-demand delivery service facilitated by the computing system 100, which can comprise marketplace-wide efficiency improvement in the movement of driver supply when facilitating menu item requests. A secondary improvement resulting from this technical approach is that driver wait times and/or menu item sit times are also minimized, which can result in highly accurate ETAs for menu items at the location of the requesting users 197. It is contemplated that such improvements in marketplace efficiency—through execution of trained wait time and sit time models 125, 135 to output predictive curves, and curve optimization techniques performed by the request processing engine 120 to determine an optimal arrival time—will result in increased user engagement and satisfaction with the on-demand delivery service.

In various implementations, the matching engine 140 can utilize the optimized arrival time outputted by the request processing engine 120 in order to match the menu item request from the requesting user 197 to a particular delivery provider 192. The delivery providers 192 may be operating throughout a service region of the on-demand delivery service (e.g., a metropolitan area) and can transmit, periodically or continuously, location data to the computing system 100 via an executing provider application 191 on their computing devices 190. Given a particular menu item request from a requesting user 197, the matching engine 140 can determine a set of candidate delivery providers 192 based on a current location of delivery providers 192 being within a threshold proximity (e.g., distance proximity or time proximity) to the location of the menu item preparer that corresponds to the menu item request.

Based on the locations of each candidate delivery provider 192 in the candidate set, the matching engine 140 may then determine an ETA of each candidate delivery provider 192 from that delivery provider's 192 current location to the location of the menu item preparer 185. In performing the ETA calculation, the matching engine 140 can account for traffic conditions, weather conditions, road closures, any mass egress events (e.g., concerts, sporting events, etc.), and the like. Based on the ETAs, the matching engine 140 can select a delivery provider 192 with an ETA that corresponds to the optimized arrival time outputted by the request processing engine 120. In certain examples, the matching engine 140 can select a delivery provider 192 having an ETA that is slightly greater than the optimized arrival time in order to, for example, account for positive error and/or minimize or eliminate provider wait time.

Upon selection of a delivery provider 192, the matching engine 140 can transmit a delivery invitation to the computing device 190 of the selected delivery provider 192 (e.g., via the executing provider app 191). The selected delivery provider 192 can provide a selection input to decline or accept the invitation, proceed to the location of the menu item preparer to pick up the requested menu item(s), and then travel to a location of the requesting user 197 to deliver the requested menu item(s). On a marketplace-wide scale over an entire delivery service region, the reinforcement learning engine 130—executing the provider wait model 125 and the menu item sit model 135—can provide significant savings in delivery provider wait time and menu item sit time. It is contemplated that this implementation can significantly eliminate current inefficiencies observed in the on-demand delivery industry.

Methodology

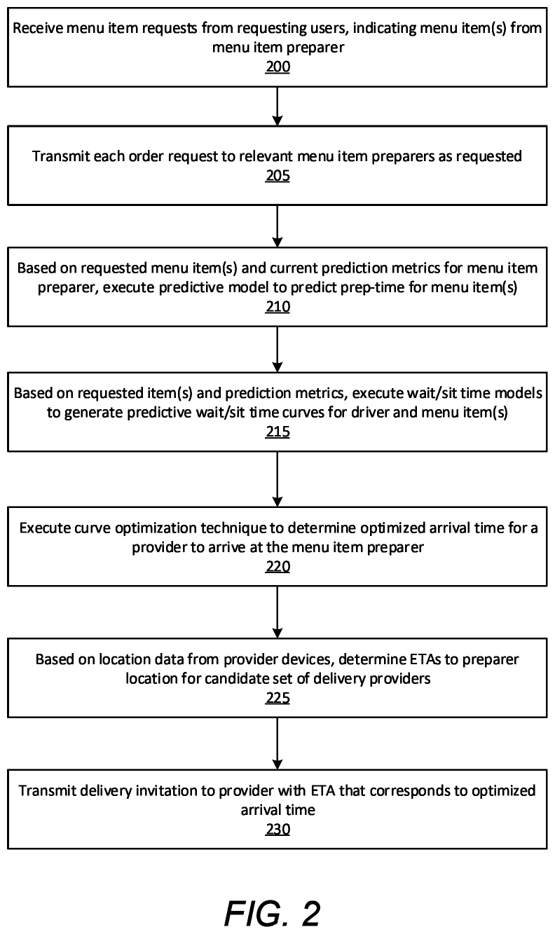

FIG. 2 is a flow chart describing an example method of generating optimal arrival times for drivers based on predictive metrics for menu item requests, according to examples described herein. In the below example of FIG. 2, reference may be made to reference characters representing like features as shown and described with respect to FIG. 1. Furthermore, the processes described with respect to FIG. 2 may be performed by the various modules and/or engines—including the executing prep-time model, the provider wait time model 125, and the menu item sit time model 135—of the computing system 100 as shown and described with respect to FIG. 1.

Referring to FIG. 2, the computing system 100 can receive menu item requests from the computing devices 195 of requesting users 197, with each menu item request indicating one or more menu items to be prepared by a specified menu item preparer 185 (200). The menu items may be predetermined by the preparer, or may be customized according to the preferences of the requesting user 197. The computing system 100 may then identify the menu item preparer 185 for each request, and transmit an order request to the menu item preparer 185 to prepare the requested menu item(s) for pickup (205). In some examples, based on the requested menu item(s) and current prediction metrics, the computing system 100 can execute a prep-time prediction model to generate a predicted prep-time for the requested menu item(s) (210). As provided herein, the current prediction metrics can be menu item preparer 185 specific based on historical data, and can further include a time of day, a day of the week, weather conditions, special event or holiday dates, order details, and the like.

Additionally or alternatively, the computing system 100 can execute a driver wait time model 125 menu item sit time model 135 using the prediction metrics for the menu item preparer 185 to generate a predictive driver wait time curve—mapping hypothetical driver wait times against overall cost (e.g., financial and/or marketplace efficiency cost) to the on-demand delivery service—and a predictive menu item sit time curve—mapping hypothetical menu item sit times against overall cost to the on-demand delivery service (215). The computing system 100 may then determine, via execution of one or more cost and/or curve optimization techniques, an optimized arrival time for a delivery provider 192 to arrive at the menu item preparer 185 (220).

In various examples, the computing system 100 can determine ETAs to the menu item preparer location for a plurality of candidate delivery providers 192 based on received location data received from positioning systems of the provider devices 190 (225). The computing system 100 may then transmit a delivery invitation to a selected delivery provider 192 having an ETA to the location of the menu item preparer that corresponds to or substantially aligns with the optimized arrival time (230). Thereafter, the delivery provider 192 may indicate an acceptance of the delivery invitation, pick up the requested items at the preparer 185, and deliver the requested items to the requesting user 197.

Delivery Interface Example

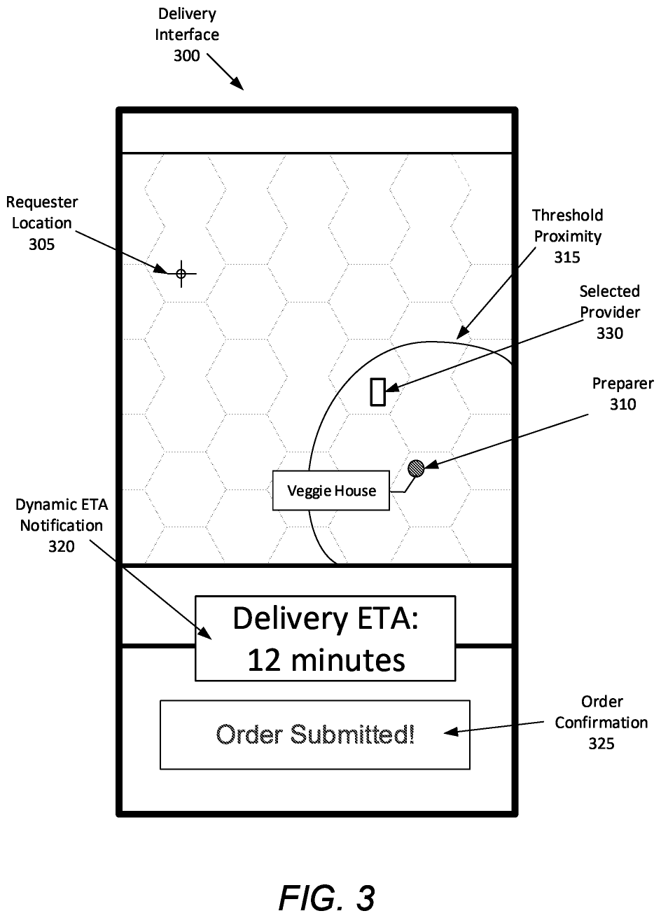

FIG. 3 depicts a delivery interface 300 for a requesting user 197 indicating an estimated time of arrival 320 that incorporates an optimal arrival time, in accordance with examples described herein. The delivery interface 300 may be presented on the computing device 195 of the requesting user 197 upon submitting a menu item request. As shown in FIG. 3, the delivery interface 300 can include a requester location 305, which can comprise a current location of the requesting user 197 or a selected delivery location at which the requesting user 197 will rendezvous with a selected delivery provider 192 to receive the requested menu items. In the example shown, the menu item preparer (shown as “Veggie House”) is centered within a threshold proximity 315, which the computing system 100 can established to identify available candidate delivery providers 192 to service the menu item request. Upon submitting the menu item request, an order confirmation 325 can be presented to the requesting user 197.

On the backend, the computing system 100 can determine the optimized arrival time described throughout the present disclosure, select the delivery provider 330 that has an ETA to the preparer location 310 that substantially matches the optimized arrival time, and transmit a delivery invitation to the selected delivery provider 330. Based on (i) the optimized arrival time or the ETA for the selected provider 330 to travel to the preparer location 330, and (ii) an ETA for the selected provider 330 to travel from the preparer location 310 to the requester location 305, the delivery interface 300 can present a dynamic ETA notification 320 that indicates when the requesting user 197 is to receive the requested menu items.

It is contemplated that ETA calculations are far more accurate than prep-time predictions, which has been the root of the accuracy problems experienced in current on-demand comestible item delivery services. It is further contemplated that as the optimized arrival time to the menu item preparer 185 becomes more and more accurate—through execution of the provider wait time and menu item sit time models 125, 135—the delivery ETA shown in the dynamic ETA notification 320 will also become more and more accurate.

Hardware Diagrams

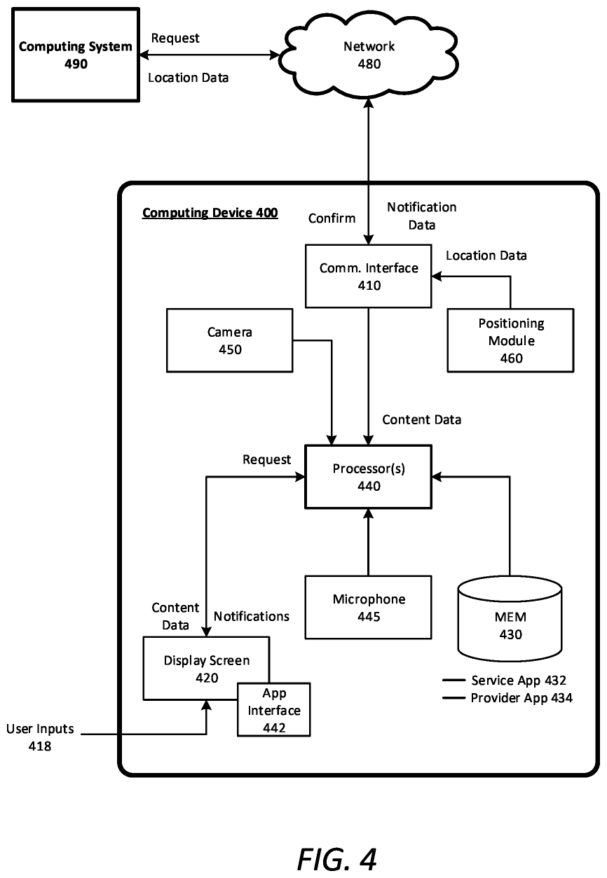

FIG. 4 is a block diagram illustrating an example mobile computing device, in accordance with examples described herein. In many implementations, the mobile computing device 400 can comprise a smartphone, tablet computer, laptop computer, VR or AR headset device, and the like. In the context of FIG. 1, the user device 195 and/or the provider device 190 may be implemented using a mobile computing device 400 as illustrated in and described with respect to FIG. 4.

According to embodiments, the mobile computing device 400 can include typical telephony features such as a microphone 445, a camera 450, and a communication interface 410 to communicate with external entities (e.g., computing system 490 implementing the on-demand delivery service) using any number of wireless communication protocols. The mobile computing device 400 can store a designated application (e.g., a service application 432 or provider application 434) in a local memory 430. The service application 432 can be selected and executed by a processor 440 to generate an app interface 442 on a display screen 420, which enables the requesting user 197 to engage with the on-demand delivery service and configure and submit a menu item request. The provider application 434 can be selected by a delivery provider 192 to receive and accept or decline delivery invitations to service menu items requests.

In response to a user input 418, the service application 432 can be executed by the processor 440, which can cause the application interface 442 to be generated on the display screen 420 of the mobile computing device 400. In implementations of the mobile computing device 400 as a provider device, the application interface 442 can enable a delivery provider to, for example, accept or reject invitations to fulfill menu item requests generated by the computing system 490. The invitations can be received as incoming service messages or notifications and acceptances of the invitations can be transmitted by the mobile computing device 400 to the computing system 490 as an outgoing service message.

In various examples, the mobile computing device 400 can include a positioning module 460, which can provide location data indicating the current location of the mobile computing device 400 to the computing system 490 over a network 480. In some implementations, location-aware or geolocation resources such as GPS, GLONASS, Galileo, or BeiDou can be implemented as the positioning module 460. The computing system 490 can utilize the current location of the mobile computing device 400 to manage the on-demand delivery service (e.g., selecting delivery providers to fulfill menu item requests, routing delivery providers 192 and/or requesting users 197, determining delivery locations for users, etc.).

The communication interface 410 is configured to receive notification data from the computing system 490 over the network 480. In response to receiving the notification data, the mobile computing device 400 can present a contextual notification (e.g., the delivery interface 300 of FIG. 3) on the display screen 420. The notifications can be presented immediately or can be displayed any time specified in the notification data. The requesting user 197 can interact with the contextual notification via user inputs 418 (e.g., a tap gesture, a swipe gesture). A specific app interface 442 of the service application 432 (e.g., a request user interface) can be presented in response to receiving the user inputs 418.

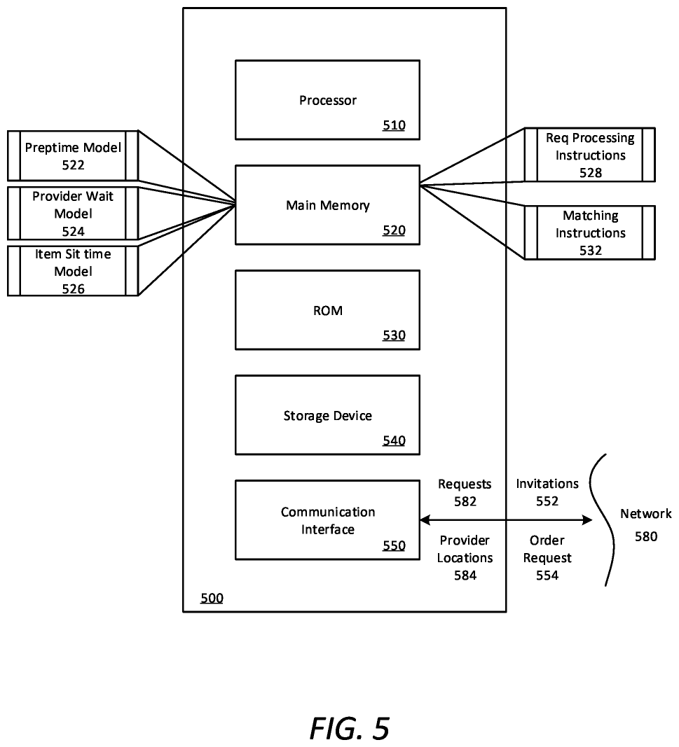

FIG. 5 is a block diagram that illustrates a computer system upon which examples described herein may be implemented. A computer system 500 can represent, for example, hardware for a server or combination of servers that may be implemented as part of a network service for providing on-demand delivery services. In the context of FIG. 1, the computing system 100 may be implemented using a computer system 500 or combination of multiple computer systems 500 as described with respect to FIG. 5.

In one aspect, the computer system 500 includes processing resources (processor 510), a main memory 520, a memory 530, a storage device 540, and a communication interface 550. The computer system 500 includes at least one processor 510 for processing information stored in the main memory 520, such as provided by a random-access memory (RAM) or other dynamic storage device, for storing information and instructions which are executable by the processor 510. The main memory 520 also may be used for storing temporary variables or other intermediate information during execution of instructions to be executed by the processor 510. The computer system 500 may also include the memory 530 or other static storage device for storing static information and instructions for the processor 510. A storage device 540, such as a magnetic disk or optical disk, is provided for storing information and instructions.

The communication interface 550 enables the computer system 500 to communicate with one or more networks 580 (e.g., a cellular network) through use of a network link (wireless or wired). Using the network link, the computer system 500 can communicate with one or more computing devices and/or one or more servers. In accordance with some examples, the computer system 500 receives menu item requests from mobile computing devices of requesting users. The executable instructions stored in the memory 530 can include a prep-time model 522 to generate predicted prep-times for requested menu items, a provider wait model 524 to generate weighted probabilities for a number of offset provider wait times at a preparer location, and an item sit time model 526 to generate weighted probabilities for a number of offset menu item sit times at the preparer location, as described throughout the present disclosure.

The executable instructions further include request processing instructions 528, which the processor 510 executes to receive menu item requests 582, transmit order requests 554 to menu item preparers, and process the prep-time prediction and probability-weighted offset times in order to generate an optimized arrival time. The executable instructions can further include matching instructions 532, which the processor 510 can execute to receive delivery provider locations 584, determine ETAs, select delivery providers that have ETAs to menu item preparers that correlate to optimized arrival times, and transmit delivery invitations 552 to their computing devices.

By way of example, the instructions and data stored in the memory 520 can be executed by the processor 510 to implement an example network system 100 of FIG. 1. In performing the operations, the processor 510 can handle menu item requests and provider statuses and submit service invitations to facilitate fulfilling the menu item requests. The processor 510 executes instructions for the software and/or other logic to perform one or more processes, steps and other functions described with implementations, such as described by FIGS. 1 through 4.

Examples described herein are related to the use of the computer system 500 for implementing the techniques described herein. According to one example, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

By performing the functions and techniques described herein, the computer system 500 is configured to receive requests 582 from user devices over the network 580 and identify appropriate service providers (e.g., based on service provider locations 584 received from provider devices over the network). The computer system can transmit invitations 552 to the identified service providers to invite the identified service providers to fulfill the requested service. In addition, the computer system 500 can generate notification data 554 to cause a user device to present a contextual notification that is specifically determined for the given user operating the user device.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A computing system comprising:
a network communication interface communicating, over one or more networks, with (i) computing devices of requesting users of an on-demand delivery service, (ii) computing devices of delivery providers of the on-demand delivery service, and (iii) computing devices of menu item preparers of the on-demand delivery service;
one or more processors; and
memory resources storing instructions that, when executed by the one or more processors, cause the computing system to:
receive, over the one or more networks, a menu item request from a computing device of a requesting user, the menu item request indicating one or more menu items from a menu item preparer;
receive, over the one or more networks, location data from the computing devices of the delivery providers, the location data indicating a current location of each of the delivery providers;
execute one or more predictive models to generate, based on a set of prediction metrics for the menu item preparer, a predictive driver wait time curve and a predictive menu item wait time curve for the one or more menu items;
using the predictive driver wait time curve and the predictive menu item wait time curve, determine an optimal arrival time for a delivery provider to arrive at the menu item preparer;
based on the location data from the computing device of the delivery providers, select a delivery provider with an estimated time of arrival at the menu item preparer that corresponds to the optimal arrival time; and
transmit, over the one or more networks, a delivery service invitation to the computing device of the selected delivery provider to pick up the one or more menu items at the menu item preparer and deliver the one or more menu items to the requesting user.

2. The computing system of claim 1, wherein the one or more predictive models comprise (i) a delivery provider wait time prediction model, and (ii) an item sit time prediction model that are tuned in an exploration phase.

3. The computing system of claim 2, wherein, in the exploration phase, the delivery provider wait time prediction model and the item sit time prediction model are tuned using at least one of (i) an upper bound search technique, (ii) a bootstrap Thompson sampling technique, or (iii) an epsilon-greedy technique.

4. The computing system of claim 2, wherein, during real-world implementation, the delivery provider wait time prediction model and the item sit time prediction model are continuously re-trained to provide increasing accuracy in probability weighting of respective offset times.

5. The computing system of claim 2, wherein, during the exploration phase, the executed instructions cause the computing system to execute a plurality of menu item request simulations using each of the delivery provider wait time prediction model and the item sit time prediction model to, at least partially, tune the delivery provider wait time prediction model and the item sit time prediction model.

6. The computing system of claim 1, wherein the set of prediction metrics comprises at least one of (i) a time of day, (ii) a day of the week, and (iii) order details for the one or more menu items requested.

7. The computing system of claim 1, wherein the executed instructions further cause the computing system to:
based on the optimal arrival time and the location data of the delivery providers, determine a set of candidate delivery providers to complete the menu item request for the requesting user, the set of candidate delivery providers being within a threshold proximity of the menu item preparer;
wherein the selected delivery provider is selected from the set of candidate delivery providers.

8. A non-transitory computer-readable medium storing instructions that, when executed by one or more processors of a computing system, cause the computing system to:
communicate, over one or more networks, with (i) computing devices of requesting users of an on-demand delivery service, (ii) computing devices of delivery providers of the on-demand delivery service, and (iii) computing devices of menu item preparers of the on-demand delivery service;
receive, over the one or more networks, a menu item request from a computing device of a requesting user, the menu item request indicating one or more menu items from a menu item preparer;
receive, over the one or more networks, location data from the computing devices of the delivery providers, the location data indicating a current location of each of the delivery providers;
execute one or more predictive models to generate, based on a set of prediction metrics for the menu item preparer, a predictive driver wait time curve and a predictive menu item wait time curve for the one or more menu items;
using the predictive driver wait time curve and the predictive menu item wait time curve, determine an optimal arrival time for a delivery provider to arrive at the menu item preparer;
based on the location data from the computing device of the delivery providers, select a delivery provider with an estimated time of arrival at the menu item preparer that corresponds to the optimal arrival time; and
transmit, over the one or more networks, a delivery service invitation to the computing device of the selected delivery provider to pick up the one or more menu items at the menu item preparer and deliver the one or more menu items to the requesting user.

9. The non-transitory computer-readable medium of claim 8, wherein the one or more predictive models comprise (i) a delivery provider wait time prediction model, and (ii) an item sit time prediction model that are tuned in an exploration phase.

10. The non-transitory computer-readable medium of claim 9, wherein, in the exploration phase, the delivery provider wait time prediction model and the item sit time prediction model are tuned using at least one of (i) an upper bound search technique, (ii) a bootstrap Thompson sampling technique, or (iii) an epsilon-greedy technique.

11. The non-transitory computer-readable medium of claim 9, wherein, during real-world implementation, the delivery provider wait time prediction model and the item sit time prediction model are continuously re-trained to provide increasing accuracy in probability weighting of respective offset times.

12. The non-transitory computer-readable medium of claim 9, wherein, during the exploration phase, the executed instructions cause the computing system to execute a plurality of menu item request simulations using each of the delivery provider wait time prediction model and the item sit time prediction model to, at least partially, tune the delivery provider wait time prediction model and the item sit time prediction model.

13. The non-transitory computer-readable medium of claim 8, wherein the set of prediction metrics comprises at least one of (i) a time of day, (ii) a day of the week, and (iii) order details for the one or more menu items requested.

14. The non-transitory computer-readable medium of claim 8, wherein the executed instructions further cause the computing system to:
based on the optimal arrival time and the location data of the delivery providers, determine a set of candidate delivery providers to complete the menu item request for the requesting user, the set of candidate delivery providers being within a threshold proximity of the menu item preparer;
wherein the selected delivery provider is selected from the set of candidate delivery providers.

15. A computer-implemented method of remotely facilitating on-demand delivery, the method being performed by one or more processors of a computing system and comprising:
communicating, over one or more networks, with (i) computing devices of requesting users of an on-demand delivery service, (ii) computing devices of delivery providers of the on-demand delivery service, and (iii) computing devices of menu item preparers of the on-demand delivery service;
receiving, over the one or more networks, a menu item request from a computing device of a requesting user, the menu item request indicating one or more menu items from a menu item preparer;
receiving, over the one or more networks, location data from the computing devices of the delivery providers, the location data indicating a current location of each of the delivery providers;
execute one or more predictive models to generate, based on a set of prediction metrics for the menu item preparer, a predictive driver wait time curve and a predictive menu item wait time curve for the one or more menu items;
using the predictive driver wait time curve and the predictive menu item wait time curve, determine an optimal arrival time for a delivery provider to arrive at the menu item preparer;
based on the location data from the computing device of the delivery providers, select a delivery provider with an estimated time of arrival at the menu item preparer that corresponds to the optimal arrival time; and
transmit, over the one or more networks, a delivery service invitation to the computing device of the selected delivery provider to pick up the one or more menu items at the menu item preparer and deliver the one or more menu items to the requesting user.

16. The method of claim 15, wherein the one or more predictive models comprise (i) a delivery provider wait time prediction model, and (ii) an item sit time prediction model that are tuned in an exploration phase.

17. The method of claim 16, wherein, in the exploration phase, the delivery provider wait time prediction model and the item sit time prediction model are tuned using at least one of (i) an upper bound search technique, (ii) a bootstrap Thompson sampling technique, or (iii) an epsilon-greedy technique.

18. The method of claim 16, wherein, during real-world implementation, the delivery provider wait time prediction model and the item sit time prediction model are continuously re-trained to provide increasing accuracy in probability weighting of respective offset times.

19. The method of claim 16, wherein, during the exploration phase, the executed instructions cause the computing system to execute a plurality of menu item request simulations using each of the delivery provider wait time prediction model and the item sit time prediction model to, at least partially, tune the delivery provider wait time prediction model and the item sit time prediction model.

20. The method of claim 15, wherein the set of prediction metrics comprises at least one of (i) a time of day, (ii) a day of the week, and (iii) order details for the one or more menu items requested.
